(19) United States
(12) Patent Application Publication
(10) Pub. No.: US 2022/0003117 A1
(43) Pub. Date: Jan. 6, 2022

(54) Rotary Piston Machine and Method for Producing a Seal in a Rotary Piston Machine

(71) Applicant: Freefreeze GmbH, Hamburg (DE)

(72) Inventors: Merlin Bungart, Hamburg (DE); Jakob Bombardi, Hamburg (DE)

(21) Appl. No.: 17/281,249

(22) PCT Filed: Oct. 14, 2019
(86) PCT No.: PCT/EP2019/077831

§ 371 Date: Mar. 30, 2021

(30) Foreign Application Priority Data
Oct. 16, 2018 (DE) 102018125624.8

(51) Int. Cl. F01C 1/077; F04C 2/077; F04C 18/077; F01C 19/00; F04C 15/00; F04C 27/00

(52) U.S. Cl. CPC F01C 1/077; F04C 2/077; F04C 27/00; F01C 19/00; F04C 15/0003; F04C 18/077

(57) ABSTRACT

A rotary piston engine and a method for manufacturing a sealing in a rotary piston engine are described. The rotary piston engine has at least two piston pairs respectively connected via a link, the pistons of which are arranged at opposite ends of the links and, during operation, circulate on an at least approximately circular path in a piston housing, such that varying working volumes are enclosed between the pistons of different piston pairs during the circulation and that, via a sealing provided between the piston housing and the pistons, a fluid flow between the enclosed working volumes is at least impeded. The technical solution described is characterized in that the sealing is formed by a gap between the pistons and the piston housing and surfaces of the pistons and the piston housing delimiting the gap at least at times are irregularly structured.

### CROSS REFERENCE TO RELATED APPLICATIONS

This application is the U.S. national stage of International Application No. PCT/EP2019/077831, filed on 2019 Oct. 14. The international application claims the priority of DE 102018125624.8 filed on 2018 Oct. 16; all applications are incorporated by reference herein in their entirety.

### BACKGROUND

The invention relates to a rotary piston engine with a special sealing between the moving pistons and the piston housing as well as a method for manufacturing a sealing in a rotary piston engine.

Rotary piston engines are power or working machines, in which the parts performing mechanical work perform rotational movements. Depending on the design of a rotary piston engine, various possibilities to convert energy into rotational movement are known. If the energy is available in the form of hydraulic or pneumatic pressure, then it is possible to use so-called vane motors. If, on the other hand, energy is available in a chemically bound form, in particular in the form of gaseous or liquid fuel, then a rotary piston engine can be designed as a thermal power machine.

The essential difference to reciprocating piston engines consists in the fact that, in a rotary piston engine, the moving parts performing mechanical work perform a periodical rotational movement. Here, energy conversion takes place in different cycle sequences, which include, for example, filling and blowing-out during the rotational movement of the pistons in the piston space. In general, rotary piston engines are used in pumps, compressors, as well as compressed-air and combustion engines. The advantage of rotary piston engines consists in the fact that fewer moving parts are present than in reciprocating piston engines, so that rotary piston engines have a comparatively simple and robust design. Furthermore, the power transmission via crankshafts required in reciprocating piston engines is absent here.

A generic rotary piston engine is known from EP 3 022 444 B1. The rotary piston engine described is characterized in that, due to special controlling, the compression ratio can be varied as needed. For that, gearwheels or suitable actuators are provided, with the adjustment of which the piston movement can be changed in a targeted manner during operation.

Furthermore, a rotary piston engine having a housing with a shaft mounted in the housing is known from DE 36 24 842 A1. In an annular space, rotating bodies are arranged, which rest against the walls of the annular space in a sealing manner. Each rotating body has four outwardly extending sector-shaped vanes. The two rotating bodies are arranged coaxially, wherein their vanes engage with each other, so that respectively one vane of one rotating body is arranged between two vanes of the other rotating body. On the basis of controlling the curved path, it is to be achieved that, upon rotation of the driveshaft, both rotating bodies perform rotations with cyclical changes in the rotational speed and the distances between the vanes.

Furthermore, a rotary piston engine is known from U.S. Pat. No. 6,422,841 B2, in which two piston pairs are arranged offset from one another, which perform a rotational movement. The pistons of the piston pairs are moved on a circular path in the piston housing by means of gearwheels coupled to a driveshaft. During the movement of the pistons, pistons of various piston pairs respectively enclose a cyclically changing working volume.

A disadvantage of rotary piston engines compared to reciprocating piston engines frequently is the sealing of the rotating pistons towards the housing. In contrast to reciprocating piston engines, sealing must be provided at different levels. Furthermore, it is a problem that, upon using sealing elements, there either are significant signs of wear or relatively strong friction losses result in a decrease in performance of the rotary piston engine. In general, non-satisfactory sealing in this area results in leakage flows between the neighboring working spaces and thus in efficiency losses of the entire machine.

### SUMMARY

Based on the rotary piston engines known from the state of the art as well as the problems described above, the invention is based on the object to specify such a machine, which can be operated in various performance ranges with comparatively high efficiency. In particular, gap losses inside the rotary piston engine, which are caused by leakage flows between neighboring working spaces, are to be minimized. Likewise, it is to be ensured that the minimization of leakage flows can be realized with technically simple means. By means of the rotary piston engine to be specified, it should in particular be ensured that, upon operation of the machine at a nominal operating speed intended for operation, leakage flows occurring are particularly low or, in this operating range of the rotary piston engine, maximum efficiency is achieved, resp. The rotary piston engine to be specified should furthermore provide special operational safety, smooth running and stability of the system components used. Furthermore, a method should be specified, using which, in a comparatively simple manner, a sealing between pistons and piston housing can be realized, which, on the one hand, at least considerably hinders the occurrence of leakage flows between working spaces and, on the other hand, can be manufactured without great constructive effort. In particular, the manufacturing tolerances for the manufacture of the remaining elements of a rotary piston engine should not decrease due to the use of such a sealing.

The object described above is solved by means of a rotary piston engine according to claim 1. A method, using which a rotary piston engine with a suitable sealing for minimizing internal leakage flows is manufactured, is stated in claim 16. Advantageous embodiments of the invention are the subject matter of the dependent claims and are set forth in more detail in the following description, partially referring to the figures.

### DETAILED DESCRIPTION

According to the invention, a rotary piston engine with at least two piston pairs respectively connected via a link, the pistons of which are arranged at opposite ends of the links and, in operation, circulate on an at least approximately circular path in a piston housing, such that varying volumes are enclosed between the pistons of different piston pairs during the circulation, and with a sealing provided between the piston housing and the pistons, which at least impedes a fluid flow between the enclosed volumes, has been further developed such that the sealing is formed by a gap between the pistons and the piston housing and that surfaces of the pistons and of the piston housing at least temporarily delimiting the gap are irregularly structured. In that, the essential idea of the invention is based on realizing a comparatively simple, in continuous operation comparatively low-wear and still effective sealing between the rotating pistons and the piston housing. According to the invention, commonly provided sealing elements, which are subject to wear, must be exchanged at regular intervals and result in additional frictional losses, are omitted.

Rather, the gap between the moving surfaces of the rotating pistons and the piston housing is designed such that leakage flows between neighboring working spaces enclosed by the rotating pistons of different piston pairs are minimized. Here, in the area of the gaps, which are moved together with the rotating pistons in the piston space, no regular structures or sealing elements are provided, but the surfaces of the pistons and/or of the piston housing comprise an irregular surface structure. At the same time, the gaps are dimensioned such that, immediately prior to commissioning of the rotary piston engine, surfaces of the pistons as well as of the piston housing delimiting the gap touch at least in sections. In an advantageous manner, this surface structure has been generated directly upon commissioning of the rotary piston engine by means of a running-in or grinding-in, resp., process, wherein the surfaces of the pistons have at least partially come into contact with the housing surface, such that a suitable structured surface delimiting the gap has formed. Thus, a rotary piston engine designed according to the invention comprises a particularly effective and likewise easily manufactured sealing in the area of the gap between the rotating pistons and the piston housing.

According to a particular further development of the invention, it is provided that a gap height is chosen such that the mean vertical distance between opposing surfaces of the pistons and of the piston housing lies in a range of 0.02 mm, in an optimal operating range, in particular in the optimal operating point, and up to 0.15 mm, upon operation outside the optimal operating range, in particular below an optimal operating point. Particularly preferred, the gap height, i.e., the vertical distance between the surface of the pistons as well as the surface of the piston housing, is 0.05 to 0.08 mm. In a special embodiment, the rotary piston engine is designed such that the gap height, prior to starting the grinding-in process, lies in a range of 0.01 to 0.03 mm and that, with the grinding-in process, the gap height reaches the values stated above directly after commissioning of the rotary piston engine.

Furthermore, according to a special embodiment, means are provided to adjust the gap distance between the pistons and the piston housing during operation of the rotary piston engine at least in the axial direction, i.e., vertical to a plane, in which the pistons move, as needed. With such a relative movement between pistons and piston housing in the axial direction, the grinding-in process can be controlled or, as far as suitable sensors are provided, even regulated.

According to a special further development, the pistons and the piston housing comprise different materials, at least in the area of the surface delimiting the gap. Here, it is preferably provided that, in the area of the surface delimiting the gap, the pistons comprise a more wear-resistant material, in particular a harder one than the piston housing.

In order to ensure an increased wear-resistance of the pistons' surface, it is further conceivable that the surfaces of the pistons in the area of the gap, which they delimit at least unilaterally, comprise a suitable coating. It is likewise conceivable that the pistons comprise a suitable oxide layer in this area, which is characterized by particular wear-resistance. For example, a piston manufactured from an aluminum material could have been electrolytically oxidized or surface-treated with the eloxal process, resp., so that the topmost layer of the pistons has increased wear-resistance. In this case, an oxide layer protective layer on aluminum is generated by anodic oxidation. The protective layer results from conversion of the topmost metal layer into an oxide or hydroxide, resp., layer, wherein a 5-25 μm thin layer is formed, which is characterized by particularly high wear-resistance.

In a particular embodiment, a comparatively soft material, such as brass, bronze, plastic or cast iron, is used for the piston housing in the area of a surface delimiting the gap. If bronze is used for the piston housing in the area of a surface at least unilaterally delimiting the gap, then this shall mean an alloy having a copper content of at least 60% by weight. In this connection, it is, in principle, conceivable to use an aluminum bronze, a lead bronze, a manganese bronze or a phosphor bronze.

If brass is used for the piston housing at its surface in this area, then this shall be a copper alloy having a zinc content of maximum 40% by weight. If cast iron is used at the surface of the piston housing, then this shall be a ferrous material with a particularly high carbon content, namely with a content of more than 2% by weight and in this differing from common steel materials.

According to a very special further development, red brass is used for the piston housing at least in the area of its surface delimiting the gap. This is a copper-based alloy, which comprises copper, tin, zinc and lead. According to DIN EN 1982, suitable copper-tin-zinc-lead alloys are marked with the abbreviations CC 490K to CC 493K. Besides a copper content of 81-90% by weight, the materials preferably comprise 1.5-11% by weight of tin, 1-9% by weight of zinc, as well as 1-8% by weight of lead.

According to a special further development of the invention, it is provided that the surfaces delimiting the gap have been structured by a grinding-in process, in which the opposing surfaces of the pistons as well as of the piston housing are at least at times brought into contact during a circular movement of the pistons in their installed position in the piston housing. Here, in a preferred manner, the structuring of the surface in the area of the gap has been generated at nominal operating speed directly upon commissioning of the rotary piston engine. Due to the respectively generated structuring at the surface on the surfaces delimiting the gaps, a particularly suitable sealing is realized, which is particularly suitable for operation of the rotary piston engine at nominal operating speed. The gaps are thus characterized by a comparatively small clearance as well as narrow tolerances. During the grinding-in process, surface structures are created in the area of the gaps on the at least at times opposing surfaces of the pistons and of the piston housing, which structures rest on one another at least at times during the rotational movement of the pistons and so the gap has a minimum height during operation of the rotary piston engine.

In a further embodiment, a ratio of an average height of a piston in the radial direction to a width of the piston in the axial direction is 2:1. According to a very special embodiment, at an average height of the pistons in the radial direction of 80 mm and an outer diameter of the piston pair of 200 mm at a speed of 600 rpm, a maximum gap height of 0.12 mm results for the gaps between the piston and the piston housing.

Preferably, the piston pairs are driven via internal planetary gears. In that, the planetary gears, which in turn are in operative connection with the driveshaft, are located in a housing, which is, at least partially, circulated by the pistons. It is advantageous, if the pistons are, at least indirectly, connected with at least one planet wheel of the planetary gears arranged inside the pistons or between the pistons of a piston pair, resp., via a piston rod connection. In this manner, a particularly space-saving drive of the piston pairs is realized. Preferably, the gears are arranged inside the piston housing such that the housing of the gears partially protrudes from the piston housing, and thus there is the possibility to cool the gears from outside with a cooling medium, in particular with cooling air, in a comparatively simple fashion.

Furthermore, according to a special further development, it is provided that the pistons comprise at least one hollow space inside. Such a hollow space has the advantage that relatively low masses have to be moved. Furthermore, with the hollow pistons, simpler cooling of the pistons as well as a pressure accumulator, e.g., for bleed-air-assisted sealing concepts, can be realized.

Furthermore, it is advantageous, if the shell surface delimiting the piston in the radial direction is not continuously curved, but comprises at least two surfaces, which enclose an angle. Preferably, the shell surface of at least one piston comprises two inclined surfaces, which ascend from edges of the pistons oppositely arranged in the axial direction towards a centerline of the shell surface extending in the direction of movement of the pistons. Preferably, both pistons of a piston pair comprise a shell surface at their outer circumference, which is designed such that a section arranged through the center of rotation of the piston pair and between the centerpoints of the centerlines extending on the shell surfaces in the direction of movement has a maximum diameter of a piston pair. According to a special further development, the piston housing surface in an area, which lies opposite the shell surfaces during the piston movement, is designed equally, and thus likewise has inclined surfaces, so that a gap height between the shell surfaces of the rotating pistons and the piston housing surface is at least approximately constant.

According to a preferred embodiment of the rotary piston engine according to the invention, there is a certain clearance in the area of neighboring sealing surfaces of the gear housings and/or the piston housing and a gear housing. Therefore, in this area, i.e., between different gear housings and/or between gear housing and piston housing, seals are preferably used, which tolerate a certain clearance, in particular a clearance of about 0.1 mm. Preferably, labyrinth seals with labyrinth passages in mesh are used here.

Furthermore, the invention also relates to a method for manufacturing an at least partial sealing of a gap between a piston housing of a rotary piston engine and at least one piston, which, in operation, circulates on an at least approximately circular path in the piston housing, in which components of the rotary piston engine are manufactured and assembled such that surfaces of the pistons and of the piston housing touch at least in sections during the circulation of the piston in the piston housing, and in which surfaces delimiting the gap are structured at least in sections during a grinding-in process subsequent to commissioning of the rotary piston engine. According to the method for manufacturing the sealing between pistons and piston housing provided according to the invention, it is thus provided that the opposing surfaces touch at least partially following their assembly and that there is a grinding-in process between the pistons and the piston housing upon commissioning of the rotary piston engine. If the surfaces of the pistons, in an advantageous manner, comprise a more wear-resistant material, in particular a harder one compared to the surfaces of the piston housing, the surface of the piston housing wears away at least stronger than the surface of the pistons. Thus, in a preferred manner, a suitable structuring of the surfaces delimiting the gap is generated.

In a particular embodiment of the invention, it is provided that the grinding-in process is executed, at least at times, at a nominal operating speed of the rotary piston engine. The rotary piston engine is usually operated in the range of this nominal operating speed, so that, in this manner, a sealing is generated, which especially in this operating point at least minimizes the occurrence of leakage flows.

According to a further embodiment, means are furthermore provided, which during the grinding-in process generate a relative movement in the axial direction between the pistons and the piston housing at least at times. In this case, the grinding-in process is supported by the means stated above, and thus, in a special manner, suitable structuring at the surface is realized.

### BRIEF DESCRIPTION OF THE DRAWINGS

Hereinafter, the invention is set forth in more detail on the basis of special embodiments and referring to the figures, without restriction of the general idea of the invention, in which:

FIG. 1: is a view of a piston housing of a rotary piston engine with pistons rotatably mounted therein;

FIG. 2: is a perspective view of a piston pair;

FIG. 3: is a top and cross-sectional view of a piston pair; as well as

FIG. 4: is a cross-sectional view of a rotary piston engine with a sealing between the rotatably mounted pistons and the piston housing designed according to the invention.

### DETAILED DESCRIPTION OF THE PREFERRED EMBODIMENTS

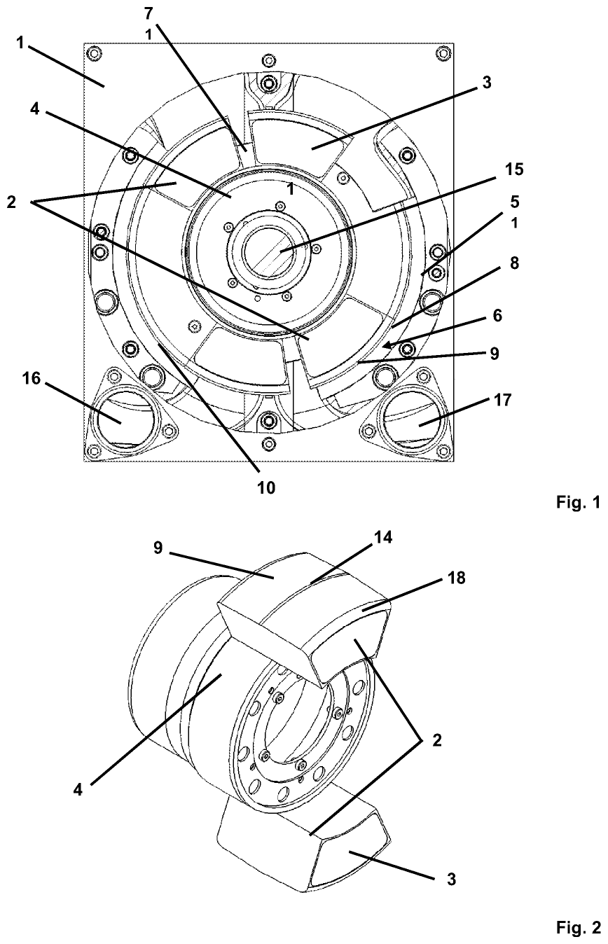

FIG. 1 shows a piston housing 5 of a rotary piston engine 1 with pistons 3 rotatably mounted therein. Two piston pairs 2 are provided, wherein the pistons 3 are respectively arranged at the ends of links 4 of the piston pairs 2. During operation of the rotary piston engine 1, the pistons 3 circulate on a circular path, such that a different volume 7, a so-called working volume, is respectively enclosed between the pistons 3 of the different piston pairs 2. In this manner, four equivalent working volumes are realized in the embodiment shown. Thus, upon operation of the rotary piston engine 1, the individual operating points alternate in a cyclical fashion.

Here, driving of the pistons 3 takes place via a driveshaft 15, which is connected with the pistons 3 or the piston pairs 2, resp., via planetary gears 11. Via respective inlets 16 and outlets 17, a working medium, preferably air, flows into the working spaces and is alternatingly compressed and expanded, wherein the working volumes 7 alter respectively. Due to heat dissipation carried out in the meantime, the depicted rotary piston engine 1 according to the embodiment described here can be used as a cooling unit for providing cooling air. In an advantageous manner, in this case, air is used as the working or cooling medium, resp.

In order to minimize leakage flows between the neighboring working volumes 7 at least to a large extent, a sealing 6 is provided between the surfaces 9, 10 of the pistons 3 and of the piston housing 5. According to the embodiment shown, the sealing is realized by a gap 8, wherein the surfaces 9, 10 delimiting the gap 8 are irregularly structured. The mean gap height, i.e., the vertical distance between the surfaces 9, 10 delimiting the gap 8, at a rotational movement of the pistons with 600 rpm is max. 0.12 mm.

The surfaces 9, 10 in the area of the gaps 8 comprise a structuring, which has been generated during a grinding-in process immediately upon commissioning of the rotary piston engine 1. This grinding-in process and the respective structuring of the surfaces 9, 10 delimiting the gap takes place immediately after assembly of the rotary piston engine 1, in particular of the piston pairs 2 in the piston housing 5. In that, no additional sealing elements are provided.

FIG. 2 shows a piston pair 2 in a perspective view, as it is used in a rotary piston engine 1 designed according to the invention. In such a rotary piston engine 1, two of these piston pairs 2 are arranged such that the pistons 3 engage with one another offset from one another. Upon a rotation, i.e., a circulation on a circular path, the pistons 3 enclose a varying working volume 7 located in the working spaces between them.

The outer delimiting surfaces 9 of the pistons 3 in the radial direction have a special shape. This is made visible in FIG. 2 with the edge depicted. While the pistons have a radius 18 at their outer flank, the outer delimiting surface 9 of the pistons 3 in the axial direction respectively has a slight incline from outside towards the center 14. Due to this design of the outer delimiting surfaces or shell surfaces 9, resp., of the piston 3, a particularly process-reliable grinding-in process of the piston surfaces as well as, above all, of the piston housing surfaces can be realized. A structuring of the surface of the pistons and/or of the piston housing achieved by the grinding-in process preferably can be achieved with a simultaneous relative movement between piston and piston housing.

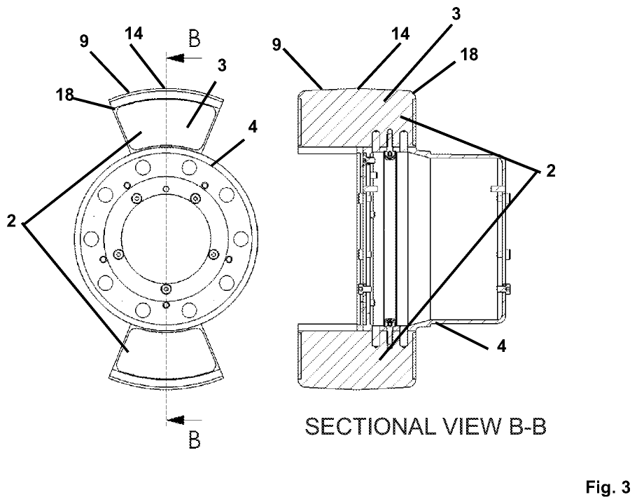

In addition, FIG. 3 shows a top view as well as a cross-sectional view of a piston pair 2 designed according to the invention. In the cross-sectional view “B-B”, once again, the design of the external delimiting surface 9 of the piston 3 circumferential in the radial direction can be clearly seen. Clearly recognizable is the inclination of the surface 9 between the center 14 of the surface 9 and the outer edges. The outer edges of the pistons 3 in turn have a curve 8. The two pistons 3 of the depicted piston pair 2 are connected with one another via a link 4 and rotate jointly upon operation of a rotary piston engine 1. The surfaces 9 of the pistons, which in the installed position delimit a gap 8 together with surfaces 10 of a piston housing 5, are in turn structured in a suitable manner, wherein the structuring has been generated by means of a grinding-in process, in which the surface of the pistons 3 has been brought into contact with the surface 10 of the piston housing 5 at least in sections.

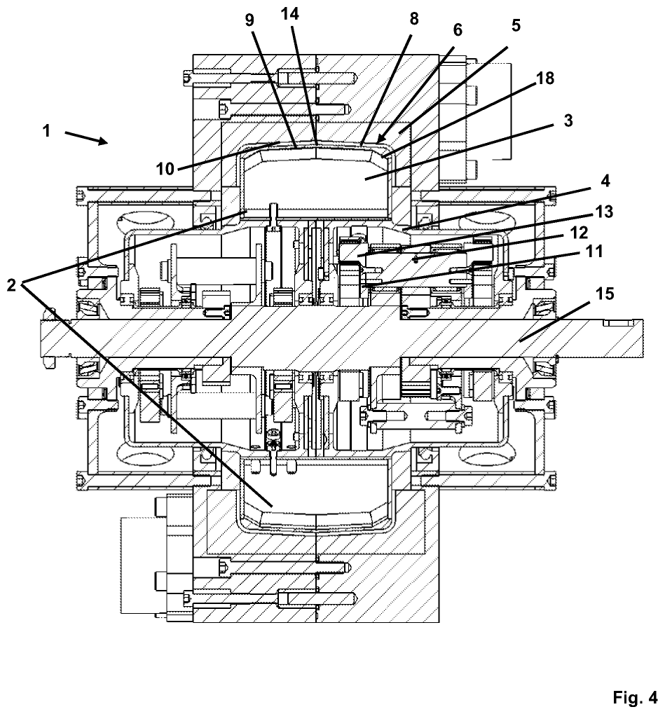

FIG. 4 shows a rotary piston engine 1 with a piston housing 5 in a cross-sectional view, in which housing two piston pairs 2, of which one is depicted in this view, are rotatably mounted. Driving of the rotary piston engine 1, which is preferably used as a cooling unit, takes place via a centrally mounted driveshaft 15. From the driveshaft 15, power and torque are first transmitted onto planetary gears 11, and then from these onto the piston pairs 2 or the pistons 3, resp. Via a piston rod connection 12, the pistons 3 are in operative connection with the planet wheels 13 of the planetary gears 11.

Essential to the invention is the sealing 6 between the surfaces 9, 10 of the pistons 3 and of the piston housing 5. With the sealing 6, it is ensured that leakage flows between the individual working volumes 7 is minimized and thus the efficiency of the respectively designed rotary piston engine 1 is maximized. Between the surfaces 9 of the pistons 3 and the surface 10 of the piston housing, a continuous gap 8 is provided, which moves with the pistons during the rotation of the pistons 3 within the piston housing 5. The sealing 6 is achieved with suitable dimensioning of the gap 8 as well as structuring of the surfaces 9, 10 of the pistons 3 as well as of the piston housing 5. It is essential that the surface 9 of the pistons 3 is designed more wear-resistant than the surface 10 of the piston housing 5.

During a grinding-in process immediately after commissioning of the rotary piston engine 1, the surfaces 9, 10, in particular the surface 10 of the piston housing 5, are structured such that leakage flows between the individual working volumes 7 are minimized. In the embodiment depicted in FIG. 4, the pistons 3 are manufactured from aluminum, wherein the outer surfaces 9 are provided with an oxide protective layer by means of an eloxal process. The surface 10 of the piston housing 5, on the other hand, comprises brass, which compared to the surface 9 of the pistons 3 is soft and not wear-resistant in the same manner, so that during the grinding-in process, a special structure is ground-in, in particular into the surface 10 of the piston housing 5, which is complementary to the surface structure of the surface 9 of the moving pistons 3 opposite at least at times. Therefore, in particular the surface 10 of the piston housing 5 comprises a suitable structuring, so that the gap 8 between the piston surfaces 9 and the housing surface 10 is designed comparatively narrow.

### LIST OF REFERENCE NUMERALS

1 Rotary piston engine
2 Piston pair
3 Pistons
4 Link
5 Piston housing
6 Sealing
7 Working volume
8 Gap
9 Piston surface
10 Piston housing surface
11 Planetary gears
12 Piston rod connection
13 Planet wheel
14 Center of the circumferentially outer piston surface
15 Driveshaft
16 Inlet
17 Outlet
18 Radius

1.-20. (canceled)

21. A rotary piston engine (1) with at least two piston pairs (2) respectively connected via a link (4), the pistons (3) of which are arranged at opposite ends of the links (4) and, during operation, circulate on an at least approximately circular path in a piston housing (5), such that varying working volumes (7) are enclosed between the pistons (3) of different piston pairs (2) during the circulation, and with a sealing (6) provided between the piston housing (5) and the pistons (3), which at least impedes a fluid flow between the enclosed working volumes,
characterized in that the sealing (6) is formed by a gap (8) between the pistons (3) and the piston housing (5), in which no sealing elements are arranged, and that the gap (8) is designed such that leakage flows between neighboring working spaces are minimized, wherein surfaces (9, 10) of the pistons (3) and of the piston housing (5) delimiting the gap (8) at least at times have a surface structure generated directly upon commissioning by means of a running-in or grinding-in, resp., process.

22. The rotary piston engine according to claim 21,
characterized in that a gap height of the gap (8) between the pistons (3) and the piston housing (5) is chosen such that a mean distance between opposing surfaces (9, 10) of the pistons (3) and of the piston housing (5) lies in a range of 0.02 and 0.14 mm.

23. The rotary piston engine according to claim 21,
characterized in that a gap height of the gap (8) between the pistons (3) and the piston housing (5) is chosen such that a mean distance between opposing surfaces (9, 10) of the pistons (3) and of the piston housing (5) lies in a range of 0.05 and 0.08 mm.

24. The rotary piston engine according to claim 21,
characterized in that a gap height of the gap (8) between the pistons (3) and the piston housing (5) is chosen such that a mean distance between opposing surfaces (9, 10) of the pistons (3) and of the piston housing (5) does not exceed 0.15 mm at nominal operating speed.

25. The rotary piston engine according to claim 21,
characterized in that the pistons (3) comprise a material, at least in the area of the surfaces (9, 10) delimiting the gap (8), which differs from a material, which the piston housing (5) comprises at least in the area of the surfaces (9, 10) delimiting the gap (8)

26. The rotary piston engine according to claim 25,
characterized in that, in the area of the surface (9) delimiting the gap (8), the pistons (3) comprise a harder material than the piston housing (5) in the area of the surface (10) delimiting the gap (8).

27. The rotary piston engine according to claim 21,
characterized in that the surfaces (9, 10) of the pistons (3) and/or of the piston housing (5) delimiting the gap (8) at least at times comprise a coating at least in sections.

28. The rotary piston engine according claim 21,
characterized in that the surfaces (9) of the pistons (3) delimiting the gap (8) comprise an oxidic protective layer at least in sections.

29. The rotary piston engine according to claim 21,
characterized in that the piston housing (5), at least in the area of the surface (10) delimiting the gap (8), comprises a synthetic material, a copper alloy with a zinc content no higher than 40% by weight, an alloy with a copper content of more than 60% by weight, or cast iron.

30. The rotary piston engine according to claim 21,
characterized in that the piston housing (5), at least in the area of the surface (10) delimiting the gap (8), comprises red brass.

31. The rotary piston engine according to claim 21,
characterized in that the surfaces (9, 10) delimiting the gap (8) have been structured by a grinding-in process, in which the opposing surfaces (9, 10) of the pistons (3) as well as of the piston housing (5) are brought into contact at least at times during a circular movement of the pistons (3) in their installed position in the piston housing (5).

32. The rotary piston engine according to claim 21,
characterized in that a ratio of an average height of a piston (3) in the radial direction to a width of the piston (3) in the axial direction is 2:1.

33. The rotary piston engine according to claim 21,
characterized in that the piston pairs (2) are connected with at least partially internal planetary gears (11).

34. The rotary piston engine according to claim 32,
characterized in that the piston pairs (2) are at least indirectly connected with a planet wheel (13) of the planetary gears (11) via at least one piston rod connection (12).

35. The rotary piston engine according to claim 21,
characterized in that the pistons (3) comprise at least one hollow space in their interior.

36. The rotary piston engine according to claim 21,
characterized in that a height of the gap (8) between at least one of the pistons (3) and the piston housing (5) varies in the axial direction.

37. The rotary piston engine according to claim 35,
characterized in that the height of the gap (8) between the piston (3) and the piston housing (5) in the axial direction reaches a minimum at a center (14) of the surface (9) of the piston (3).

38. The rotary piston engine according to claim 21,
characterized in that a gap between two housings of gears connected with the rotary pistons and/or between one housing of gears connected with the rotary pistons and the piston housing (5) is sealed with at least one contact seal.

39. The rotary piston engine according to claim 21,
characterized in that a gap between two housings of gears connected with the rotary pistons and/or between one housing of gears connected with the rotary pistons and the piston housing (5) is sealed with a labyrinth seal with labyrinth passages in mesh.

40. A method for manufacturing an at least partial sealing (6) of a gap (8) between a piston housing (5) of a rotary piston engine (1) and at least one piston (3), which, during operation, circulates on an at least approximately circular path in the piston housing (5), in which components of the rotary piston engine (1) are produced and assembled such that surfaces (9, 10) of the piston (3) and of the piston housing (5) touch at least in sections during the circulation of the piston (3) in the piston housing (5), and in which surfaces (9, 10) delimiting the gap (8) are structured at least in sections during a grinding-in process subsequent to commissioning of the rotary piston engine (1).

41. The method according to claim 40,
characterized in that, during the grinding-in process, a relative movement between piston (3) and piston housing (5) is initiated in the axial direction of the rotary piston engine (1) at least at times.

42. The method according to claim 40,
characterized in that the grinding-in process is performed at the nominal operating speed of the rotary piston engine (1) at least at times.
